(19) United States
(12) Patent Application Publication
(10) Pub. No.: US 2026/0320233 A1
(43) Pub. Date: Oct. 15, 2026

(54) SYSTEM AND METHOD FOR IDENTIFYING AND CONTROLLING DISTRIBUTION OF PERSONAL DATA

(71) Applicants: Everardo David Ruiz, Bellevue, WA (US); Sanjay Prasad, Los Altos, CA (US)

(72) Inventors: Everardo David Ruiz, Bellevue, WA (US); Sanjay Prasad, Los Altos, CA (US)

(21) Appl. No.: 19/405,095

(22) Filed: Dec. 1, 2025

Related U.S. Application Data
(63) Continuation of application No. 17/592,506, filed on Feb. 3, 2022, now abandoned.
(60) Provisional application No. 63/146,462, filed on Feb. 5, 2021.

(51) Int. Cl. G06F 21/62

(52) U.S. Cl. CPC G06F 21/6263

(57) ABSTRACT

A computerized system and method identifies user identifiable information by receiving a request to identify user identifiable information pertaining to one or more identified users. For a selected one of the one or more identified users, one or more devices, in a group of devices, is scanned to identify a set of accessed servers, located remotely from the one or more processors, that have been accessed by way of the one or more devices. An accessed server identifier is generated to uniquely identify each of the accessed servers. A request is generated for each accessed server of the set of accessed servers to perform one or more of, identifying user identifiable information collected by the accessed server, and deleting user identifiable information collected by the accessed server. The request is transmitted to each accessed server of the set of accessed servers together with an identifier to identify the selected one of the one or more identified users. One or more responses to the request and is received and the response is provided to the one or more identified users.

### RELATED APPLICATIONS

This application is a continuation of and claims priority to U.S. patent application Ser. No. 17,592,506 filed on Feb. 3, 2022, which application claims priority to U.S. provisional application 63/146,462 filed on Feb. 5, 2021, and entitled “SYSTEM AND METHOD FOR IDENTIFYING AND CONTROLLING DISTRIBUTION OF PERSONAL DATA,” which application is hereby incorporated by reference in its entirety.

### TECHNICAL FIELD

The present disclosure relates generally to managing computerized information and more particularly to accessing and managing information collected and stored on computerized servers.

### BACKGROUND

On-line activity, where a person browses the World Wide Web (WWW) for information, communicates and conducts transactions increasingly involves the exchange of personal information. While some activity can be conducted anonymously, much online activity involves the provision of personally identifiable information (PII), by a person using a computerized device, to a third-party. This activity can involve browsing, by way of a conventional browser, for information by way of online searches and/or following links within a website and between websites. Online activity can also include transactions where a person explicitly provides payment and related information to complete a transaction. Online activity can also be conducted on behalf of a person by way of devices and computer programs that operate autonomously or semi-autonomously. As a person's online usage grows so does the number of websites, and associated third-party entities, that possess certain amounts of a person's PII.

### BRIEF DESCRIPTION OF THE DRAWINGS

FIG. 1 is a high-level block diagram illustrating an embodiment of the disclosed system.

FIG. 2 is a high-level flow diagram illustrating operation of an embodiment of the system of FIG. 1.

FIG. 3 is a flow diagram illustrating operation of an embodiment of requestor identification of FIG. 2.

FIG. 4 is a flow diagram illustrating operation of an embodiment of URL identification of FIG. 2.

FIG. 5 is a flow diagram illustrating operation of an embodiment of request generation of FIG. 2.

FIG. 6 is a flow diagram illustrating operation of an embodiment of requestor identification communications with an Information Provider/Collector of FIG. 2.

FIG. 7 is a flow diagram illustrating an embodiment of transmission of a User Identifiable Information (UII) request to an Information Provider/Collector.

FIG. 8 is a flow diagram illustrating an embodiment of identification of a UII protocol to employ with an Information Provider/Collector.

FIG. 9 is a flow diagram illustrating an embodiment of submission of a UII request with an Information Provider/Collector.

FIG. 10 illustrates a block diagram of hardware that may be employed in an implementation of the embodiments disclosed herein employing computer-executable instructions.

### DETAILED DESCRIPTION

The disclosed embodiments which may take form of various computerized methods, which may be stored on non-transitory computerized media, and computerized systems address the growing volume and dispersion of a person's Personally Identifiable Information (PII) that is exchanged online with third party entities. The disclosed embodiments create data transparency and enable control of personal data that was previously unavailable to individuals and groups (e.g., families) using social media platforms, apps, browsers, email, and other system and application software, and across entities previously “invisible” and unknown to the individual, user, or group.

The term PII is widely used and in various contexts can have different meanings, for example as used in general usage and in legislation and regulation. In the context of this disclosure, the term User Identifiable Information (UII) is employed to refer to information associated with a user of a computerized device that can identify at least such a user by the identifier that they use in connection with such computerized device. Such an identifier may be a login identifier such as an email address or other login identifier. Such an identifier may also be a phone number or other identifier that uniquely identifies a mobile phone such as an IMEI number or SIM identifier. In some circumstances, UII may correspond to PII and in other circumstances may not identify any particular human being but may instead identify a group of individuals or an organization. For example, some login identifiers may be shared by multiple individuals in an organization or a family. In such an instance, a particular identifier will correspond to UII but not necessarily, under some definitions, comprise PII. The present disclosure pertains to improving the operation and efficiency of computerized devices by controlling the management of various information communicated between and accessed and managed by computerized devices. As such, the term UII as defined above, which refers to information entered into, recognized, transmitted and managed by computerized devices, is employed herein specifically to refer to the data upon which such computerized operations are performed.

In one embodiment, a computerized method is executable on one or more processors for identifying UII. A request to identify UII pertaining to one or more identified users is received. For each of the identified users, one or more devices in a group of devices is scanned to identify a set of accessed servers that have been accessed by way of the one or more devices. The accessed servers comprise one or more computer servers and that operate separately and independently from the one or more processors. An accessed server identifier is generated to uniquely identify each of the accessed servers. A request is generated for each accessed server of the set of accessed servers to perform one or more of, identifying UII collected by the accessed server, and deleting UII collected by the accessed server. The request is transmitted to each accessed server of the set of accessed servers together with an identifier to identify the selected one of the one or more identified users. Responses to the transmitted requestor received and the responses are provided to the one or more identified users.

The disclosed embodiments may be implemented in hardware or software on a device, “in the cloud” (such as one or more servers located remotely from the user and execute software to implement the functions and other operations described herein), or in a hybrid approach which uses both a device and “the cloud” to distribute data analysis, catalog generation, and enabling the generation of data storage/modification/deletion requests by an individual or members of a group.

One embodiment analyzes all incoming and outbound data traffic from and to one or more computerized devices, and builds a log of the following for the purpose of enabling an individual to control personal data from one or more devices, based on discovering and cataloging the following:
Uniform Resource Locators (URLs) and Internet Protocol (IP) addresses contacted, and associated entities “which touch” the device over the network via web browser or other application or system software;
Emails received on a device and email sent by a device;
Source of text messages received by a device, and destination of text messages sent by the device;
Any additional data traffic parameters such as IP addresses and text, and messaging and status parameters;
Driver apps on a device, including the app developer (entity) and data sent, and any update data sent or received;
Apps on a device, including the app developer (entity) and data sent or received;
Data sent or received that associated with a specific individual user (e.g., their account[s]).

Certain disclosed embodiments further update the “catalog” for each device by adding data from at least one of the following to enhance data protection, especially due to data sent to entities that are “invisible” to the individual:
Catalog data from other devices in a group;
Catalog data from other users or accounts in a group;
Catalog data from a given network accessed and controlled by the user or a member of a group;
Catalog data from other users or accounts in the social network of a given user or member of a group;
Catalog data from one or more additional sources, such as a master catalog or other catalogs, containing information on entities and their associated entities (as part of a constructing a more comprehensive “crowdsourced”-style catalog).

The catalog is made available to the individual user, or group involved for the purpose of enabling requests to entities concerning personal data stored by the entity, modification of that data, or deletion of the data. In one embodiment, the catalog is made available to one or more designated devices which are programmed to automatically generate the aforementioned requests to entities concerning personal data stored by the entity, modification of that data, or deletion of the data. Requests concerning personal information by an individual also likely include additional information for the purpose of authenticating requests for personal data stored by an entity, modification of that data, or deletion of that data.

Reference is made in this specification to various aspects of websites available via the internet. As used herein, in a Uniform Resource Locator (URL), for example, “http://www.example.com”, moving from right to left in the URL, the “.com” label is referred to as a top-level domain. Moving to the left, each label specifies a subdomain of the domain to the right. So, the label “example” specifies a subdomain of the top-level domain label “.com”, and the label “www” specifies a subdomain of the subdomain “example”. For simplicity of reference the first subdomain of the top-level domain may be referred to as a first level subdomain and a subdomain of the first level subdomain may be referred to as a second level subdomain, and this nomenclature can be extended for further level subdomains (third level, fourth level, etc.). In the foregoing example, the “http” designation refers to a protocol, in this case, the hypertext transfer protocol. In the URL http://www.example.com, the labels www.example.com may also be referred to collectively as a hostname. A URL may also include a path component, consisting of a sequence of path segments separated by a slash (/), to, for example, specify a particular file to be provided to a user, such as by being rendered on a browser. For example, a URL such as www.example.com/first_file.html, when accessed by a user's browser will cause the file named “first_file.html” located at hostname www.example.com to be rendered on the user's browser. The path component may specify multiple levels such as for example, www.example.com/special/second_file.html. In such an example, the file named “second_file.html” located in a folder named “special” that is located at hostname www.example.com when accessed by a user's browser will be rendered by the browser. In the foregoing example, the files that are rendered on a user's browser, such as “first_file.html” and “second_file.html” may also each be referred to as a “webpage”. In the foregoing example, the webpages “first_file.html” and “second_file.html” may be referred to as being within or accessible by the hostname “example.com”.

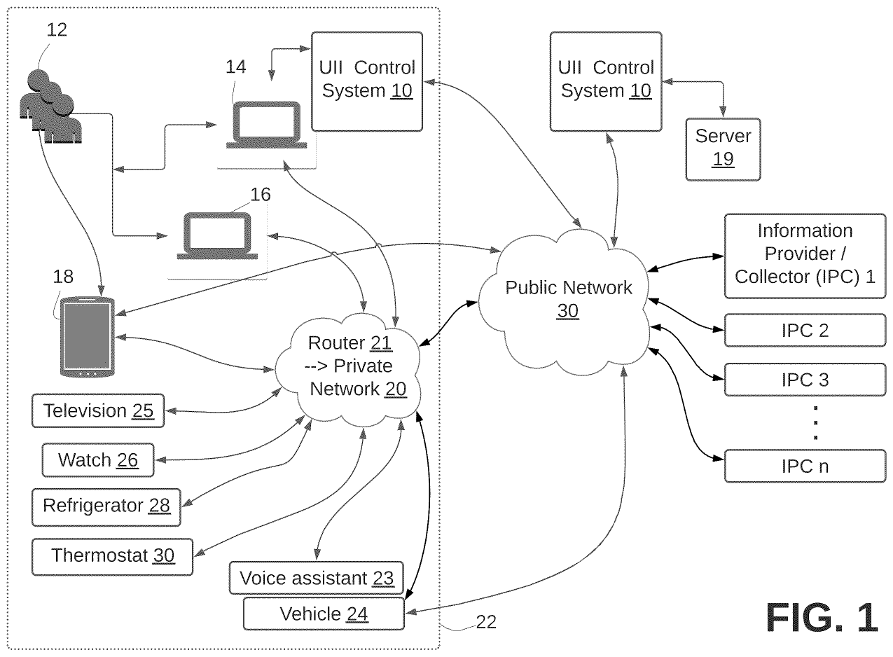

Any given hostname will be identified by an IP address and in some cases a single hostname may be identified by, and accessed by, multiple IP addresses. This may occur for example when a single website, e.g., www.example.com, is hosted in more than one location. In many cases a hostname will correspond to an Information Provider Collector (IPC) as seen in FIG. 1. In some cases, multiple hostnames may correspond to a single IPC. For example, www.example.com and www.example2.com may both correspond to the same repository in which an organization maintains UII.

FIG. 1 is a high-level block diagram illustrating an embodiment of the disclosed system. In FIG. 1, UII (User Identifiable Information) control system 10 operates to control the UII of one or more users 12 that is collected and stored by various Information Providers and Collectors (IPCs). An IPC will often provide information to a user and may collect information on the user in the process. Some IPCs may only provide information and not collect any UII of a user. Other IPCs may collect UII of a user but may not in the course of such collection may not provide any information to a user or may provide information that may not be of interest to a user. The UII control system 10 may execute as one or more software programs on one or more user devices such as a laptop or desktop computer 14, a tablet 16 or a handheld device such as a mobile phone 18. The UII control system 10 may also execute on a separate processor such as a server computer, implemented as a physical or virtual machine, 19 located remotely from the user 12. In some embodiments, the UII control system 10 may execute partially on a user device, such as via a downloaded application, and also in a remotely located device. Each of the one or more users 12 represents an individual whose UII can be managed by UII control system 10. The individuals 12 may, for example, be part of a household or may form some other group of individuals who have permitted UII control system 10 to manage and/or control their UII as described herein. The users 12 may use various devices such as 14, 16 and 18 via a private network 20 which may take the form of a local area network such as typically found in a household and be implemented by way of a Wi-Fi router 21. Access to the private network 20 may also be permitted via remotely located users and or devices by way of, for example, a virtual private network. The private network and the devices and users that have access to it are designated by virtual group 22. Within the virtual group 22 there may be additional computerized devices such as a smart voice assistant 23, a vehicle 24, a smart television 25, a smart watch 26, a smart refrigerator 28, and a smart thermostat 30. Such smart devices typically have computing and communication capability that enables communication with other computerized devices, including computerized devices located physically outside of virtual group 22. While the ability of such smart devices to communicate autonomously with devices located outside of virtual group 22 may be limited for security purposes, some of the smart devices may often communicate with multiple other devices located outside of virtual group 22. For example, a smart voice assistant 23 will often be used for voice enabled internet searching, providing music via streaming services and may serve as a conduit for other devices in virtual group 22 to communicate with devices outside of virtual group 22. Many of the smart devices may communicate with a corresponding manufacturer of the smart device to provide data for maintenance purposes. Such smart devices may also communicate with other devices located outside of virtual group 22 for other purposes. For example, a smart refrigerator may be configured to communicate with a food delivery service to order food and to identify food for future purchase, a smart wine refrigerator may provide information of its contents to enable ordering and identification of wine for future orders. Such smart devices can typically be associated with a user account and details of the user contained in the smart account may be stored by an IPC. In some instances, a user may not have explicitly created a user account but the IPC may nevertheless have collected UII that is for example associated with a device identifier of the smart device. Additionally, other UII pertaining to one or more users of the smart device may be stored such as items ordered (for a smart refrigerator), locations traveled to (for a vehicle), and maintenance information.

The private network 20 will typically have associated therewith a network address, such as an IP address (that may be dynamic or static), to enable communication over public network 30. One or more of the devices within virtual group 22 when communicating with other devices such as websites or other online computerized services will be identified at least by the IP address assigned to private network 20, or some other address if communicating separately over public network without private network 20, such as via a cellular communication network. In addition to the network address that may be communicated to a receiving website other information pertaining to a user 12 may be communicated including, for example, the user's name, address, financial information such as credit card information, and other characteristics of the user such as height, weight and various activities and preferences of the user. The websites and other online services with which the users 12 interact and provide and receive information are designated generally as IPCs and are seen in FIG. 1 as IPC 1, 2, 3, to IPC n. The users 12 may interact directly via devices such as computer or desktop 14, tablet 16, or mobile phone 18 to explicitly provide various UII. The smart devices in virtual group 22 may also provide information that will identify one or more users 12. As noted above, often such smart devices have an associated profile containing various information for one or more users 12 and such information can be UII that may be transmitted to one or more IPC's without the user's knowledge.

Before proceeding further in describing UII control system 10 it is useful to understand how information by users 12 is tracked in some typical online environments. PII may constitute a variety of information that either explicitly identifies an individual or maybe used either by itself or in conjunction with other information to generate an identification they could be used to identify a particular individual or device. Various statutes and regulations exist by which individuals may seek to control the collection and dissemination of their information. Such statutes and regulations may also provide users with the right to request that a collector of PII delete such information and or inform the user of the information that has been collected on the user and also to stop collecting PII. Examples of such current statutes and regulations include the General Data Protection Regulations (GDPR) in the European Union and the California Consumer Privacy Act (CCPA) in California. The UII control system 10 in certain embodiments permits a user 12 to perform certain of the aforementioned functions, among other things. It should be understood that information that does not explicitly identify an individual may or may not constitute PII. In some circumstances an IPC may have collected information on an individual that individually does not constitute PII but that collectively permits by inference an identification of an individual and this collection of information can therefore be considered PII. For example, an IP address by itself may not identify a particular individual, because it may cover an area that includes a large number of possible individuals. However, with other information that permits an identification, or likely identification, of an individual, an IP address may constitute PII.

Websites employ a variety of, and increasing number of, techniques for identifying a user, or certain characteristics of a user as the user engages in online activity. This tracking of the user's online activity is generally used to build up detailed profiles for increased ad-targeting. A user's browser will typically provide a variety of information about the user's device. One common technique is by way of what is commonly referred to as a “user agent” which is used by a web server communicating with a browser to serve different web pages to different web browsers. The browser provides an identification to the web server by way of a user-agent field in its HTTP header. The user-agent field can be used for example, to serve simpler web pages to older browsers. This can also be used to display different content to different operating systems-for example, by displaying a slimmed-down page on mobile devices. This can also be used to gather statistics showing the browsers and operating systems accessing the web server. This can also be used generally to cause the web server to treat the requesting entity (browser or otherwise) in a particular way. For example, if the requesting entity is of a particular type (an automated software robot, i.e., “bot”, or is from a particular source, e.g., Google) it may be permitted to bypass a registration screen typically required by the website served by the browser.

In addition to the user-agent field, a typical browser can provide a significant amount of information about the browser and the user's device. This includes identification of the browser type (such as FireFox®, Chrome®, Safari®), Internet Explorer® etc.), browser version, installed plug-ins and their versions, device hardware information such as the CPU and GPU model, the display resolution, current battery level for a portable device, the device's operating system's screen resolution, the installed fonts, the current time zone, and other information. The browser can also identify to a website if the user has disabled cookies entirely. This information collectively can make a user unique and help to identify a user.

Another simple way of identifying a user is by their IP address, which identifies the user on the Internet. Often, a user's device will share an IP address with other networked devices in the user's house or office. The IP address used by the user can be used by a website to determine the user's rough geographical location, such as the town/city or area. IP addresses can change and are often used by multiple users, so they are not by themselves a good way of tracking a single user over time. However, websites can combine an IP address with other techniques to track a user's geographical location. For example, one such technique is sometimes referred to as HTTP referrer or HTTP referral. This involves, when a user clicks a link in a webpage that is being viewed, the user's browser loading of the web page clicked and identifying to the website of the clicked webpage an identification of the source website. This information is typically contained in the HTTP referrer header portion of the information sent from the source website to the destination website. The HTTP referrer header is also sent when loading content on a web page. For example, if a web page includes an ad or tracking script, the user's browser tells the advertiser or tracking network what page the user is viewing. Another tracking technique involves encoding a web page with a “web bug,” which is a small image, such as, one-by-one pixel, that is not visible to the user which encodes an HTTP referrer header to track the user without appearing on a web page being viewed by the user. Web bugs may also be used to track emails opened by the user if the user's email client is permitted to load images.

A common technique for tracking user browsing activity is to use a “cookie,” which is a small piece of information that a website can store in the user's browser. Cookies are used for a variety of purposes and can improve the online experience such as by storing login information for a website to facilitate repeated usage of the website. Often when a user changes a setting on a website, a cookie stores that setting so the changed setting will persist across page loads and sessions. A cookie may also be used by a website to identify a user and to track the user's browsing activity across a website. One form of a cookie may be termed a “third-party cookie” which is a cookie provided by a third-party that is loaded by a website into a user's browser. Third-party cookies are often used by advertising networks to track a user across multiple websites. This permits two different websites which use the same advertising or tracking network to track and link a user's browsing history across both sites. Such third-party cookies may also be used by social networking websites to identify user preferences, for example when the user clicks on a “Like” button. This can be stored in a cookie to identify that particular user preference.

Browser's typically permit a user to remove selected ones or all cookies stored in the user's browser. This operation removes the online activity stored in the browser's cookies that is used by websites to identify the user. Many browsers employ a mode that operates to delete browsing history upon termination of the applicable tab/window. This operation of deleting the browsing history stored by the browser does not however result in deletion of any UII at the IPC.

Some applications that may be installed on a user's device may store cookies in other locations accessible by the device to persist information about the user and their browsing history, even when cookies are deleted, from the user's browser. Sometimes referred to as a “super cookie” such a cookie may be stored in multiple locations that may be accessed by way of the user's browser by way of additional applications, such as for example one or more plug-ins. One form of such a technique is to assign a unique color value to a few pixels every time a new user visits a website. The different colors are stored in each user's browser cache and can be loaded back-the color value of the pixels is a unique identifier that identifies the user. If a user has deleted a part of a super cookie, upon visiting a website the deleted information can be repopulated from another location on the user's device on which the deleted information is stored.

Another tracking technique is known as HTTP injection. This has been used by cellular communication networks but is not necessarily limited to such a network. HTTP injection involves the operator of the cellular communication network injecting some identifying information about the user into the HTTP fields of the request sent by the browser on the user's mobile device. This provides an identity to the destination website of the user, which permits delivery of more targeted advertisements. The HTTP injection is performed dynamically. Hence it is not stored on the user's browser or elsewhere on the device and cannot therefore be deleted like a cookie to avoid tracking. The HTTP injection is delivered by the communication carrier directly to the destination website and hence its existence cannot be seen by the user, such as by using the reveal codes feature of a website to view the source code of the website.

The above techniques infer user identity by virtue of identity and characteristics of the user's device, its browser and the user's browsing history. A user's identity may also be determined by information specific to the user which may be explicitly provided by the user. This information includes identification by the user of their name, date of birth, zip code, gender, etc., some of which can be provided by way of for example logging into a browser. Additionally, those skilled in the art in view of the present disclosure will recognize that the references herein to the functions and/or features of a browser also includes similar functions and/or features performed by other application software or system software that may incorporate the functions and/or features described herein for a browser.

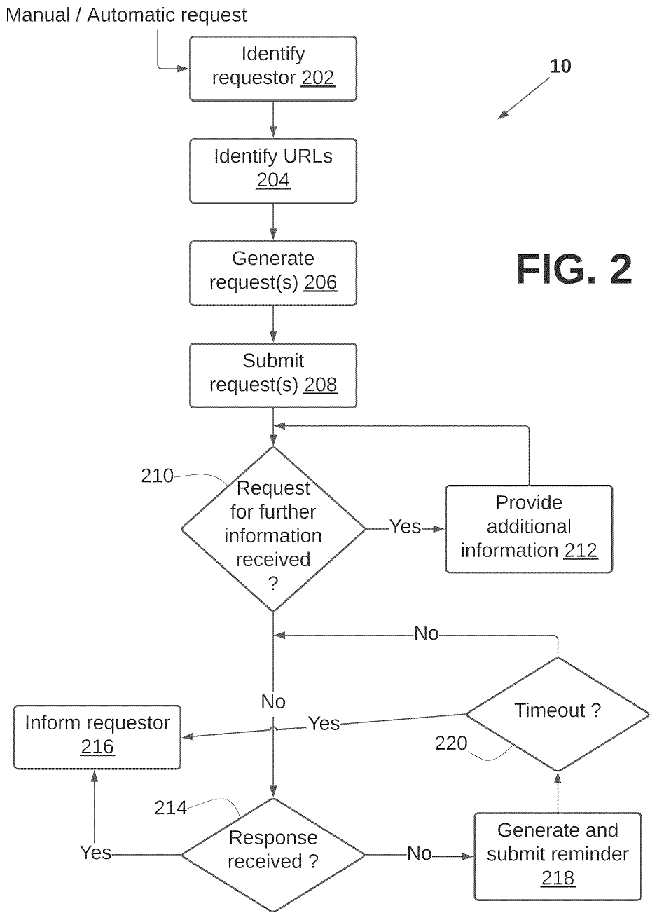

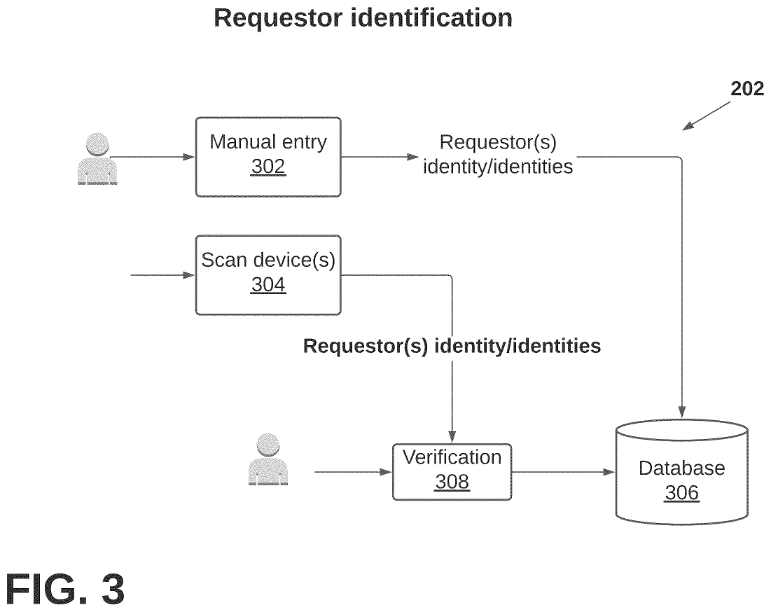

FIG. 2 is a high-level flow diagram illustrating operation of an embodiment of the system 10 of FIG. 1. The operations in FIG. 2 are initiated by submission of a request to the UII control system 10. As seen in further detail in FIG. 3, the request may be manually generated 302 by user 12 by way of a graphical user interface or other command provided to system 10 which makes a request to a database 306 to verify the identity of the requestor against information stored in the database 306. The request may also be automatically generated 304 by system 10 such as by periodic generation, for example every 30 or 45 days or semiannually, by identifying each user of one or more devices, such as in virtual group 22. At 202, the system 10 identifies the requestor. This may be performed by identifying the user 12 logged into the system 10. The identification of the request may also be performed automatically 304 and may be accompanied by a verification 308 from a user 12 by way of database 306. For example, a user 12 that has authenticated themselves with a device may initially be assumed by the system 10 to be the requestor and the system 10 will verify with the authenticated user if the authenticated user should be identified as the requestor. The authenticated user may confirm themselves as the requestor or may by way of one or more interfaces provided by the system 10 identify one of the other users 12 as a requestor. The operations shown in FIG. 2 may be performed periodically for each user 12, which may be initiated automatically by the system 10.

Next at 204 the system 10 identifies the various locations such as which IPC's and which web pages on such IPC's the requestor has visited over a specified period of time. In one embodiment this operation is performed by identifying the uniform resource locators stored on the one or more devices in the virtual group 22. Next at 206 the system 10 generates a request as specified by the requestor for each IPC identified at 204. Each of the requests at 206 is submitted at 208 to the identified IPC's. At 210 a test is performed to determine if a request from any IPC for further information for the UII request from the system 10 is required. This may be because, for example, an IPC requires further information to verify an identity of the requestor in order to provide the requested information. If additional information is required, then such information is provided at 212 and the test of 210 is performed again. If no additional information is required, then at 214 a test is performed to determine if a response from the IPC in question has been received. It should be understood that at step 206 multiple requests may be generated and operations 208 onward will be performed for each request generated at 206. It may take some time for a response to be received at 214 and when such response is received the requestor is informed at 216. In the event a response is not received at 214, a reminder may be generated and submitted to each IPC at 218. A timeout period, which may be fixed or programmable, such as by a user, is employed at 220 to allocate a period of time in which an IPC may be provided to provide a response. In the event this timeout period is reached, the requestor is informed at 216, otherwise the test at 214 is checked periodically with reminders being sent periodically at 218 until a response is either received or the timeout period is reached.

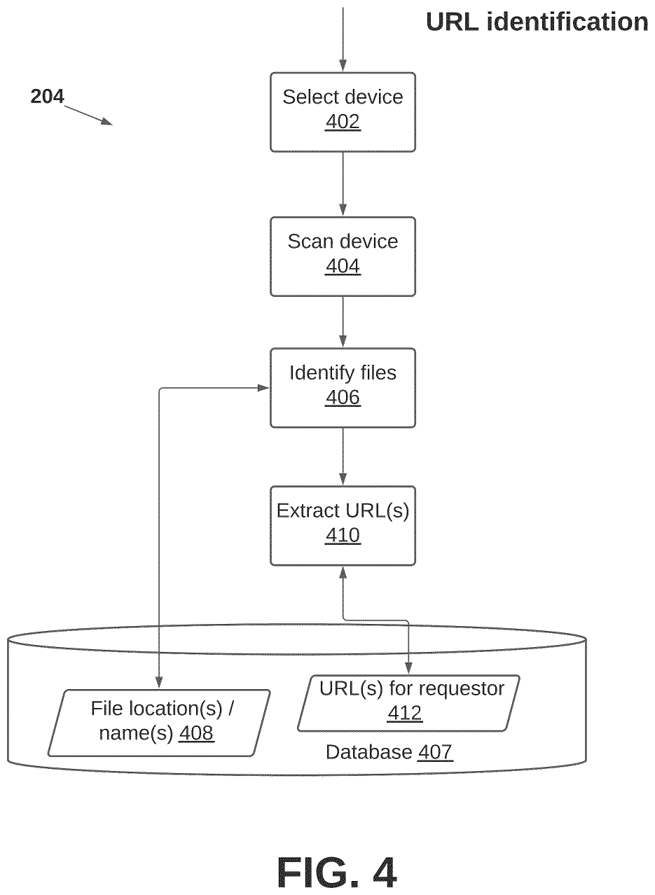

FIG. 4 is a flow diagram illustrating operation of an embodiment of URL identification of FIG. 2 performed at 204. A device among the various devices that the requestor may use or that may be in the requestor's control is first selected at 402. These devices include some or all of the devices shown in FIG. 1 within the virtual group 22. Next, each of the selected devices is scanned at 404 to identify files at 406 that may contain identifiers such as URLs for IPCs visited by the requestor. The identification at 406 may be performed by way of accessing a database 407 that store known file locations and names 408. The various identified files are then scanned to extract URLs contained therein at 410 and these extracted URLs 412 are stored to the database 407. Each device scanned may contain information such as URLs visited by others than the requestor. In some embodiments further processing can be performed to filter out URLs visited by individuals other than the requestor. The result may be that the URL's identified include URLs visited by someone other than the requestor. In some cases, this will simply result in a request involving the URLs not visited by the requestor to be denied by the IPC. The file identification in some embodiments may also include reference to stored file locations and names that provides suggestions as to likely files and locations of such files that will contain URLs. For example, certain known programs such as browsers will store browsing history in certain files and identification of such files and their locations and their likely locations can be stored to assist in the file identification. A similar process can be performed for other applications and system software that contain a history of visited URLs.

The embodiment of FIG. 4 identifies IPCs or hostnames by way of a “bottom up” approach of identifying URLs visited and identifying hostnames visited from URLs accessed. An alternative technique that employs IP address may be employed. In such a technique the devices in virtual group 22 may be scanned for IP addresses accessed to generate a listing. This listing may then be annotated to add a hostname to an IP address. For example, an IP address of 207.0.115.57 may be annotated to correspond to www.example.com. The annotation identifies instances where multiple IP addresses correspond to the same hostname. Other techniques may also be employed, such as for example, accessing a database outside of system 10 that provides a correlation between an IP address and a hostname and/or an IPC.

In one embodiment, the operations described in the preceding paragraph are performed by software routines executed by the router 21 or by a computing device associated with the router 21. This permits centralized identification of URLs visited/accessed by all devices in virtual group 22. Additionally, in one embodiment, the operations shown in FIG. 4 and describe above are performed by the router 21 or by a computing device associated with the router 21 for each device in virtual group 22. This also permits centralized identification of URLs visited/accessed by all devices in virtual group 22 and in such an embodiment such operations may be performed automatically and periodically. In some instances, it may be necessary to remove certain devices from a virtual group when UII related operations as described herein are performed. For example one or more devices identified as part of a virtual group may belong to guests who may have temporarily been granted access to the private network 20. In one embodiment, an opportunity is provided to review devices identified as having been granted access to public network 30 by way router 21 and to remove such devices so that the UII related operations described herein are not performed with respect to activity arising from such devices.

Virtual group 22 may take a variety of forms other than devices associated with a local area network. In one embodiment, virtual group 22 is formed of devices that are each associated with a common account or similar identifier for example as provided by the iCloud® or iTunes® services available from Apple, Inc.

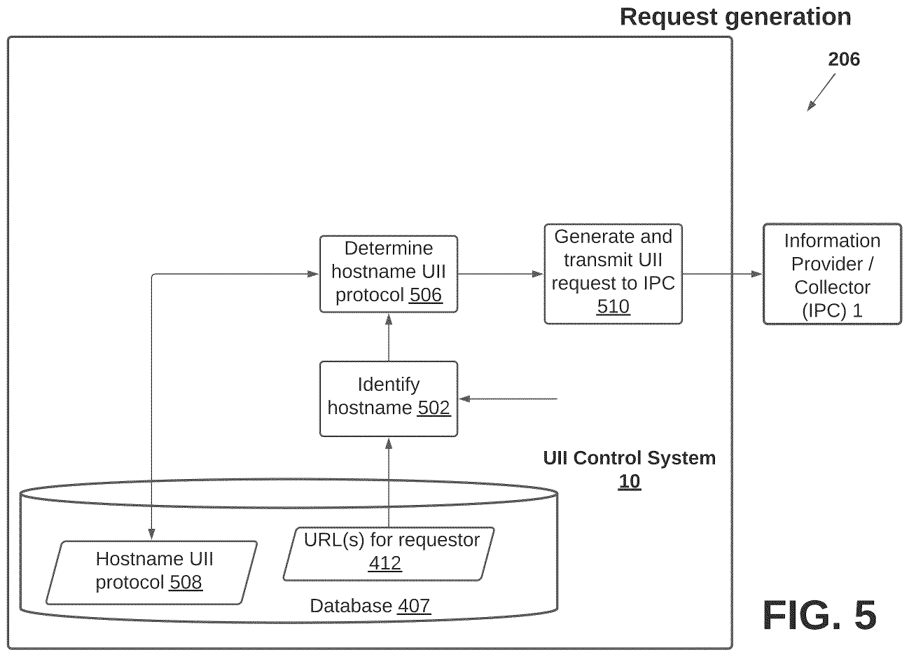

FIG. 5 is a flow diagram illustrating operation of an embodiment of request generation of FIG. 2. The operations in FIG. 5 are initiated at 502 by first identifying a hostname to which a request will be sent. This may be performed by extracting the identified URLs for requestor 412 that are stored in the database and for each of the URLs identifying a corresponding hostname at 502. This may result in duplicate hostnames and the duplicates may be discarded. Next, at 506 a protocol by which a hostname responds to user requests pertaining to UII is determined. In one embodiment this is performed by accessing database 407 of known hostname protocols 508. Then the requestors' UII request is transmitted at 510 to the IPC associated with each hostname. In this regard commonly a hostname will have a one-to-one correspondence with an IPC. In some instances, multiple hostnames may correspond to a single IPC. In some embodiments, the system 10 may resolve multiple hostnames to a single IPC such as by querying each hostname to identify an IPC or by accessing a database external to the system 10 that may contain a correlation of hostname to IPC. In some instances, the bottom-up approach disclosed herein of IPC identification, i.e., of determining IPCs accessed by browsing/communication history, can result in an overly inclusive listing of IPCs which may contain a requestor's UII. In some embodiments, a listing of IPCs identified may be presented to the requestor, or other user, to permit an editing of the listing of IPCs. In such an embodiment, the listing may include an identification of IPCs added since generation of the last UII request by the requestor.

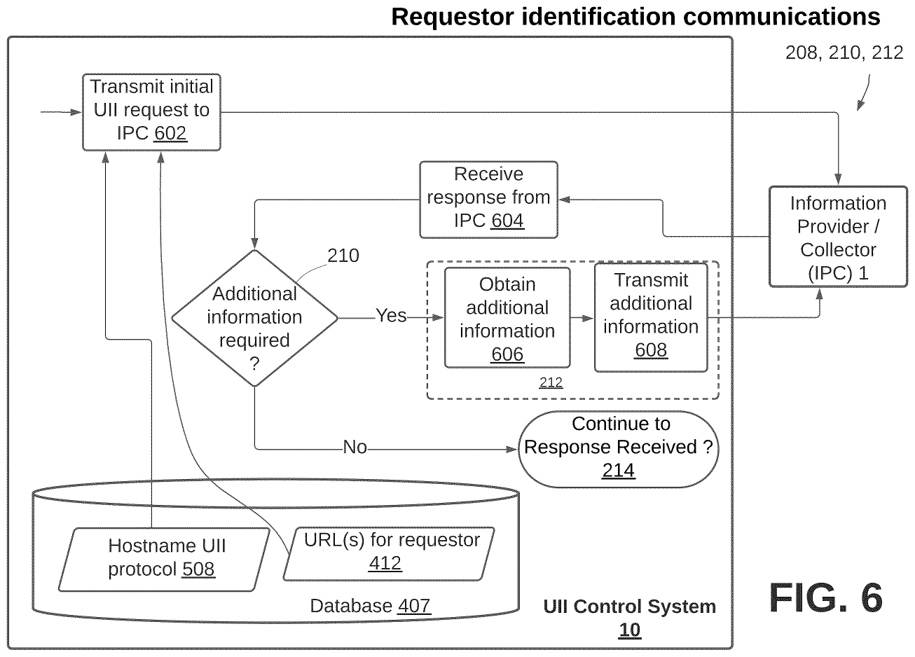

FIG. 6 is a flow diagram illustrating operation of an embodiment of requestor identification communications with an Information Provider/Collector of FIG. 2. This is initiated at 602 by transmission of an initial UII request to an IPC such as IPC 1. The request transmitted at 602 may be formed by determining the hostname protocol as stored at 508 and identifying the URL corresponding to the requestor at 504. The IPC responds to the request and the first such response may be that additional information is required. The IPC response is received 604 and if such additional information is required as determined at 210, the system 10 proceeds at 212 to obtain the additional information 606 and to transmit 608 the additional information to the IPC. Once no additional information is required, as determined at 210, the operation proceeds to the response received? Operation 214 in FIG. 2. The initial UII request transmitted to the IPC will be performed in accordance with a protocol determined by the system 10 to be used in communicating UII requests to the IPC in question. The UII request may also include URLs at the IPC visited by the requestor.

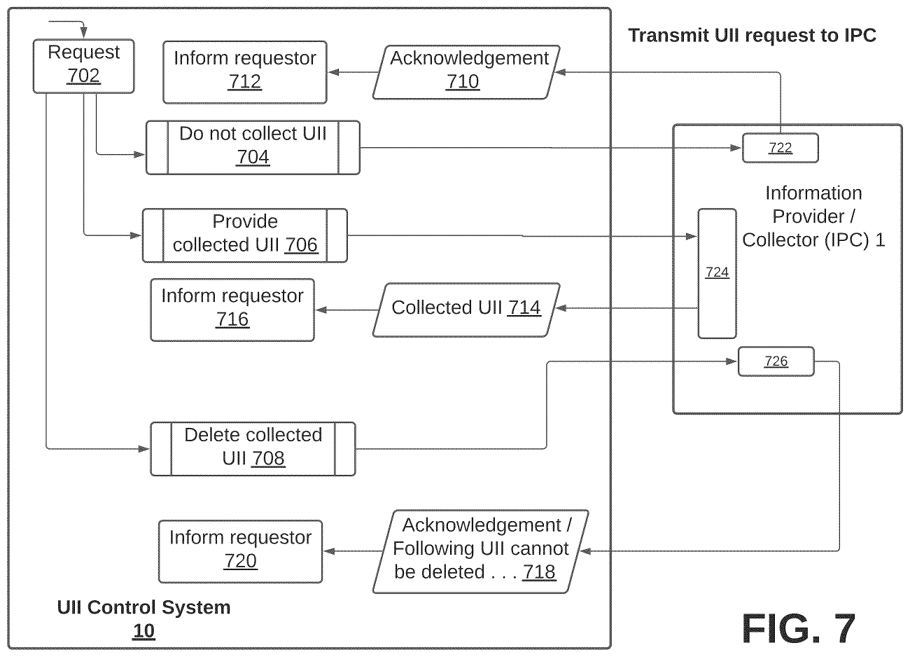

FIG. 7 is a flow diagram illustrating an embodiment of further details of transmission of a UII request to an IPC. The request 702 to the IPC may be of several different types. For example, the request may be a request 704 for the IPC to not collect UII of the requestor. Since the requestor has already visited the IPC the request to not collect UII will more accurately be a request to not continue collecting UII and such a request may be coupled with other requests as described below. The request 702 may also be a request 706 of the IPC to provide to the requestor the UII collected on the requestor. The request may also be a request 708 of the IPC to delete all or a specified subset of UII collected regarding the requestor. These requests are merely examples and other types of requests may be performed. One example of such other requests may be a combination, as suggested above, of two or more of the three example requests described herein. The request 704 to not collect UII may be followed up by the IPC with an acknowledgement 710 whereupon the system 10 informs 712 the requestor. The request 706 to provide collected UII may be followed up by the IPC by providing 714 the collected UII and the requestor thereupon being informed 716. The request 708 to delete collected UII may be followed up by the IPC by an acknowledgement 718 that the UII requested to be deleted has been deleted. In some cases, UII requested to be deleted by the requestor cannot be deleted for a variety of reasons and this information is provided to the system 10 which then informs the requestor 720. For example, requestor login information on an IPC on which the requestor has an account may not be deleted by way of a UII request but may require additional operations to be deleted if the requestor so desires. In FIG. 7, the requests 704, 706, 708 are shown to be handled by separate modules 722, 724, 726 (respectively) at IPC 1. This is shown in simplified form for explanatory purposes. The implementation at any particular IPC for handling such requests may take a variety of forms.

A request to identify UII of a requestor may in one embodiment explicitly request the following regarding the requestor: (i) the categories of personal information collected, (ii) specific pieces of personal information collected, (iii) the categories of sources from which the IPC collected personal information, (iv) the purposes for which the IPC uses the personal information, (v) the categories of third parties with whom the IPC shares the personal information, (vi) the categories of information that the IPC sells or discloses to third parties. The request may also explicitly provide a time frame over which the requested information should be provide.

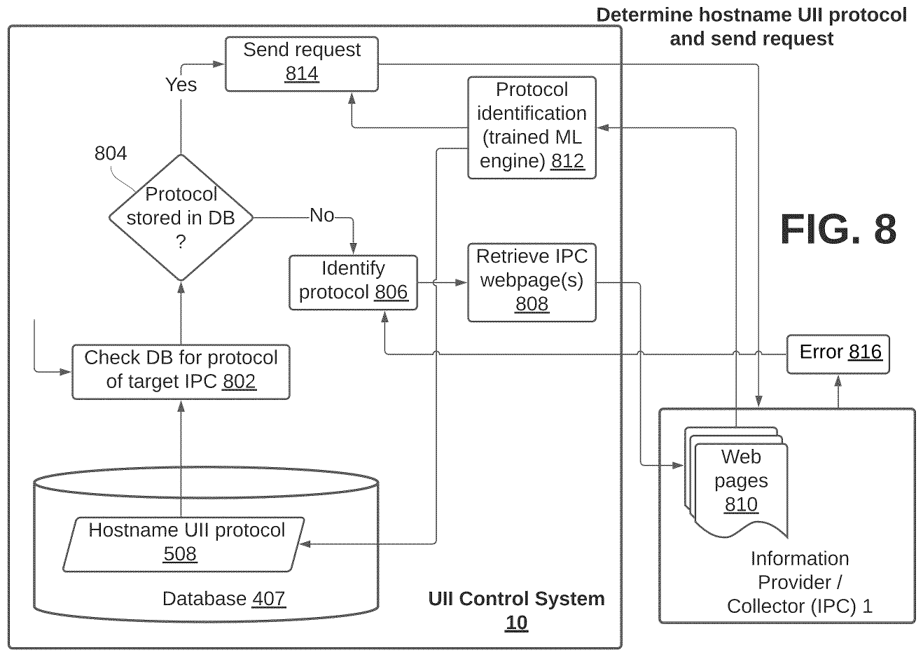

FIG. 8 is a flow diagram illustrating an embodiment of identification of a UII protocol to employ with an IPC. Determination of the protocol to employ when communicating with an IPC may be performed in a number of ways. In some cases, the protocol for the IPC in question will be known and will be stored in the database. In such an event the UII protocol is retrieved from the database and used to send the UII request. This is performed by checking at 802 the database 407 for a stored hostname PII protocol 508. If a protocol for the IPC in question is not stored in the database as determined at 804, then an operation is performed at 806 to identify the protocol. This may be performed by retrieving at 808 various web pages 810 from the IPC to determine a protocol for UII requests as stored on one or more web pages at the IPC. For example, an IPC may, at a particular URL, have a web page providing information as to how UII requests should be submitted. This operation may be simplified by first visiting URLs determined in advance to be likely locations for providing UII protocol information. For example, many IPC's may have a link at the top-level web page for privacy related information, which is likely to contain information regarding that particular IPC's UII request protocol. The various web pages retrieved from the IPC are provided to a protocol identification engine 812 to identify the appropriate protocol. In one embodiment the protocol identification engine may employ a trained machine learning engine that has been trained to recognize a UII request protocol from text and or images extracted from web pages. The identified protocol is then employed to send at 814 the UII request of the requestor to the IPC. An error handling mechanism may be employed in the event that the request at 808 at retrieve webpages 810 cannot be fulfilled. In one embodiment, an error message may be provided to protocol identification 806 which may resubmit the request. Alternatively, or additionally, the error message may be provided to engine 812 for additional training. In the event that the protocol cannot be identified a message may be provided to the user to permit use of another approach to contact the IPC.

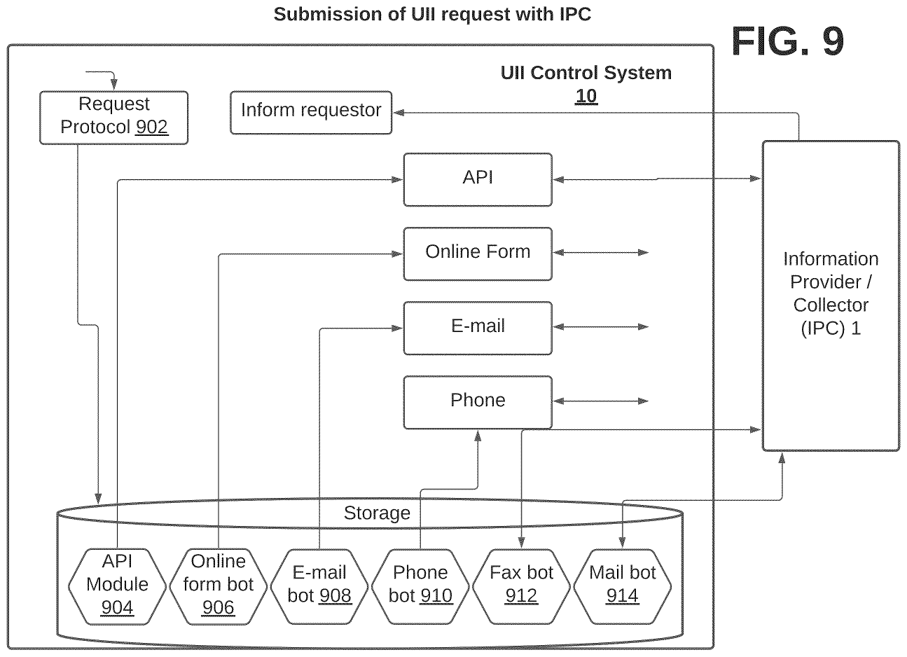

FIG. 9 is a flow diagram illustrating an embodiment of submission of a UII request with an IPC. The appropriate request protocol is received 902, and a corresponding request program is retrieved from storage. The request program may take one of a variety of forms depending upon the particular request protocol. The request protocol may comprise a programmatic interface 904 with the IPC where the system 10 interacts programmatically by way of an Application Programming Interface (API) provided by the IPC. The request program may also take the form of a “bot” which is computer software or a software “robot” that is programmed to capture and interpret an existing application provided by the IPC for receiving a UII request. Such a bot operates to interpret the user interface of the application provided by the IPC to execute steps identically as would a human user in submitting the UII request. For example, if the request protocol provided by the IPC is an online form that must be filled out with the request for information, then an online form bot 906 may be employed. If the request protocol provided by the IPC requires an email to be submitted to a particular email address with particular information regarding the requestor and the particulars of the request, then the email bot 908 may be employed. Similarly, if the request protocol provided by the IPC requires communication by phone then a phone bot 910 may be employed to make a phone call to the IPC at the phone number specified by the PC and the bot 910 will upon connection with the phone number at the IPC provide a text to voice conversion to provide an audible version of the information required to submit the UII request. Additional bots may also be employed in the event that other request protocols are employed by the IPC such as for example a fax interface or 912 or a mail bot 914 to assist in mailing the requests by way of physical mail.

In some cases, a complete identification of IPCs that have collected UII of a user may not be complete by a scan of devices which the user has used. This may be because third-party IPCs have been provided with UII of a user by way of an IPC with which the user has directly interacted. In one embodiment, the system 10 may generate a request to identify other, indirect IPCs to which the user's UII has been or may have been provided. Such a request may be independently submitted or may be submitted in conjunction with any of the other UII requests described herein. In such an embodiment, the system 10 will extract the indirect IPCs from the response to such a request and submit on behalf of a requestor a UII request, of the type(s) described herein to each of the indirect IPCs. Intermediary IPC's and/or servers that may cache content for an IPC may be similarly treated by providing information about such a server to the requestor.

In another embodiment, the system 10 may identify other IPCs whose identity cannot be determined from information stored one on of the user's devices (such as those in virtual group 22 of FIG. 1) by scanning information provided by an IPC in response to a Provide Collected UII request to identify any IPCs not identified in the original request. A separate request, of one or more types as described herein, can then be sent automatically, or manually upon user input, to each newly identified IPC.

Online information collection continues to evolve, and any number of techniques may exist, or may be developed, in which a user's UII is collected without leaving any indication of such collection by the collecting IPC. In one embodiment, the system 10 periodically scans third party websites for the identity of IPCs that collect information on users and adds such IPCs to its database so that such IPCs can be added automatically to the request of a requestor, or suggested to the requestor to be added, to a UII request. This may be done periodically to increase a user's control over their UII.

In one embodiment, the system 10 permits a requestor to provide payment in conjunction with a request pertaining to UII. Some regulations require a number of types of PII requests, such as a right to opt-out, to delete collected PII or to identify collected PII to be provide at certain intervals without charge to the requestor. The ability to pay for a UII request enables the system 10 to permit a requestor to avail themselves of PII related services by IPCs or third parties that may require a fee.

Aspects of certain of the embodiments herein can be implemented employing computer-executable instructions, such as those included in program modules and/or code segments, being executed in a computing system on a target real or virtual processor. Generally, program modules and code segments include routines, programs, libraries, objects, classes, components, data structures, etc. that perform particular tasks or implement particular abstract data types. The program modules and/or code segments may be obtained from another computer system, such as via the Internet, by downloading the program modules from the other computer system for execution on one or more different computer systems. The functionality of the program modules and/or code segments may be combined or split between program modules/segments as desired in various embodiments. Computer-executable instructions for program modules and/or code segments may be executed within a local or distributed computing system. The computer-executable instructions, which may include data, instructions, and configuration parameters, may be provided via an article of manufacture including a computer readable medium, which provides content that represents instructions that can be executed. A computer readable medium may also include a storage or database from which content can be downloaded. A computer readable medium may also include a device or product having content stored thereon at a time of sale or delivery. Thus, delivering a device with stored content, or offering content for download over a communication medium may be understood as providing an article of manufacture with such content described herein.

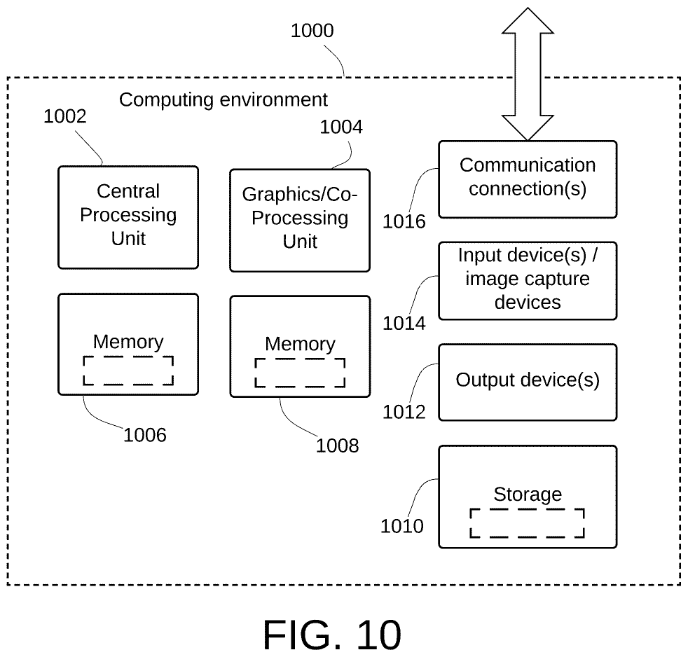

FIG. 10 illustrates a block diagram of hardware that may be employed in an implementation of the embodiments disclosed herein employing computer-executable instructions. FIG. 10 depicts a generalized example of a suitable general-purpose computing system 1000 in which the described innovations may be implemented in order to improve the processing speed and efficiency with which the computing system 1000 operates to perform the functions disclosed herein. With reference to FIG. 10 the computing system 1000 includes one or more processing units 1002, 1004 and memory 1006, 1008. The processing units 1002, 1006 execute computer-executable instructions. A processing unit can be a general-purpose central processing unit (CPU), processor in an application-specific integrated circuit (ASIC) or any other type of processor. The tangible memory 1006, 1008 may be volatile memory (e.g., registers, cache, RAM), non-volatile memory (e.g., ROM, EEPROM, flash memory, etc.), or some combination of the two, accessible by the processing unit(s). The hardware components in FIG. 10 may be standard hardware components, or alternatively, some embodiments may employ specialized hardware components to further increase the operating efficiency and speed with which the system 10 operates. The various components of computing system 1000 may be rearranged in various embodiments, and some embodiments may not require nor include all of the above components, while other embodiments may include additional components, such as specialized processors and additional memory.

Computing system 1000 may have additional features such as for example, storage 1010, one or more input devices 1014, one or more output devices 1012, and one or more communication connections 1016. An interconnection mechanism (not shown) such as a bus, controller, or network interconnects the components of the computing system 1000. Typically, operating system software (not shown) provides an operating system for other software executing in the computing system 1000, and coordinates activities of the components of the computing system 1000.

The tangible storage 1010 may be removable or non-removable, and includes magnetic disks, magnetic tapes or cassettes, CD-ROMs, DVDs, or any other medium which can be used to store information in a non-transitory way, and which can be accessed within the computing system 1000. The storage 1010 stores instructions for the software implementing one or more innovations described herein.

The input device(s) 1014 may be a touch input device such as a keyboard, mouse, pen, or trackball, a voice input device, a scanning device, or another device that provides input to the computing system 1000. For video encoding, the input device(s) 1014 may be a camera, video card, TV tuner card, or similar device that accepts video input in analog or digital form, or a CD-ROM or CD-RW that reads video samples into the computing system 1000. The output device(s) 1012 may be a display, printer, speaker, CD-writer, or another device that provides output from the computing system 1000.

The communication connection(s) 1016 enable communication over a communication medium to another computing entity. The communication medium conveys information such as computer-executable instructions, audio or video input or output, or other data in a modulated data signal. A modulated data signal is a signal that has one or more of its characteristics set or changed in such a manner as to encode information in the signal. By way of example, and not limitation, communication media can use an electrical, optical, RF, or other carrier.

The terms “system” and “computing device” are used interchangeably herein. Unless the context clearly indicates otherwise, neither term implies any limitation on a type of computing system or computing device. In general, a computing system or computing device can be local or distributed and can include any combination of special-purpose hardware and/or general-purpose hardware with software implementing the functionality described herein.

While the invention has been described in connection with the disclosed embodiments, it is not intended to limit the scope of the invention to the particular form set forth, but on the contrary, it is intended to cover such alternatives, modifications, and equivalents as may be within the spirit and scope of the invention as defined by the appended claims.

1-20. (canceled)

21. A computerized method, executable on one or more processors, for identifying user identifiable information comprising:
receiving a request to identify user identifiable information pertaining to one or more identified users; and
for a selected one of the one or more identified users,
scanning a plurality of devices, wherein the plurality of devices form at least a portion of a virtual group, wherein the virtual group is formed of devices connected to a private network and one or more identified users that have access to the private network, wherein each device in the plurality of devices in the virtual group is accessible by the selected one of the one or more identified users to access an accessed server, wherein the scanning is performed by way of a router or a computing device associated with the router that operates on the private network to centrally identify, for each device in the plurality of devices, URLs accessed by that device, and wherein the scanning of the plurality of devices identifies a set of accessed servers that comprise one or more computer servers, located remotely from the one or more processors, that have been accessed by way of the plurality of devices in the virtual group;
generating for each of the accessed servers an accessed server identifier to uniquely identify each of the accessed servers;
generating a request for each accessed server of the set of accessed servers to perform one or more of, identifying user identifiable information collected by the accessed server, and deleting user identifiable information collected by the accessed server;
transmitting the request to each accessed server of the set of accessed servers together with a user identifier to identify the selected one of the one or more identified users; and
receiving one or more responses to the request and providing the one or more responses to the selected one of the one or more identified users.

22. The computerized method of claim 21 wherein the user identifiable information comprises information associated with the selected one of the one or more identified users that can identify the selected one of the one or more identified users by the user identifier.

23. The computerized method of claim 21 wherein the request to identify user identifiable information pertaining to one or more identified users is generated by one of the one or more identified users.

24. The computerized method of claim 21 wherein the request to identify user identifiable information pertaining to one or more identified users is generated periodically and automatically upon selection of an automatic request by one of the one or more identified users, wherein the automatic request is initiated by the one or more processors at a predetermined periodic interval without further input from the one or more identified users.

25. The computerized method of claim 21 wherein the virtual group is automatically generated by:
operating the router or computing device associated with the router to periodically scan each of the plurality of devices connected to the private network to identify each user identifier employed by each of the devices to identify each individual using the corresponding device, and
adding each identified device to the virtual group based on its connection to the private network and the user identifiers employed on that device.

26. The computerized method of claim 21 wherein each device in the plurality of devices is identified by at least a first device identifier that uniquely identifies a corresponding device.

27. The computerized method of claim 21 wherein the operation of scanning a plurality of devices to identify a set of accessed servers that have been accessed by way of the plurality of devices comprises:
selecting a device of the plurality of devices;
scanning each selected device to identify files that may contain identifiers for accessed servers, wherein the scanning is performed by the router or the computing device associated with the router; and
extracting and storing URLs from files identified that may contain identifiers for accessed servers.

28. The computerized method of claim 27 wherein the operation of scanning each selected device to identify files that may contain identifiers for accessed servers comprises accessing a database that stores known file locations and names of files that store identifiers.

29. The computerized method of claim 27 further comprising further processing stored URLs from files identified that may contain identifiers for accessed servers to filter out URLs visited by individuals other than the requestor, wherein the filtering is performed by comparing the user identifier associated with the requestor against user identifiers associated with stored URLs to identify and exclude URLs associated with other users of the devices in the virtual group.

30. The computerized method of claim 27 further comprising further processing stored URLs from files identified that may contain identifiers for accessed servers to identify references to stored file locations and names that provides suggestions as to likely files and locations of such files that contain URLs.

31. The computerized method of claim 21 wherein the operation of generating an accessed server identifier to uniquely identify each of the accessed servers comprises generating a hostname corresponding to each of the accessed servers.

32. The computerized method of claim 21 wherein the operation of generating a request for each accessed server of the set of accessed servers to perform one or more of, identifying user identifiable information collected by the accessed server, and deleting user identifiable information collected by the accessed server comprises:
identifying a protocol by which each accessed server responds to a request to perform one or more of, identifying user identifiable information collected by the accessed server, and deleting user identifiable information collected by the accessed server, wherein the identifying of the protocol comprises: (i) checking a database of stored hostname protocols to determine if a protocol for the accessed server is stored; and (ii) if a protocol is not stored, retrieving one or more web pages from the accessed server and providing the retrieved web pages to a protocol identification engine to identify the protocol, wherein the protocol identification engine employs a trained machine learning engine trained to recognize a user identifiable information request protocol from text or images extracted from web pages.

33. The computerized method of claim 21 wherein the operation of receiving one or more responses to the request and providing the one or more responses to the one or more identified users comprises:
determining if the one or more responses to the request is of a type that requests further information to provide the one or more responses to the one or more identified users; and
if further information is requested by the accessed server, obtaining the further information and transmitting the further information to the accessed server to enable the accessed server to provide the requested user identifiable information.

34. A computerized method, executable on one or more processors, for identifying user identifiable information comprising:
receiving a request to identify user identifiable information pertaining to one or more identified users;
for a selected one of the one or more identified users,
scanning a plurality of devices, wherein the plurality of devices form at least a portion of a virtual group, wherein the virtual group is formed of devices connected to a private network and one or more identified users that have access to the private network, wherein each device in the plurality of devices in the virtual group is accessible by the selected one of the one or more identified users to access an accessed server, wherein the scanning is performed by way of a router or a computing device associated with the router that operates on the private network to centrally identify, for each device in the plurality of devices, URLs accessed by that device, and wherein the scanning of the plurality of devices identifies a set of hostnames associated with servers located remotely from the one or more processors that have been accessed by way of the plurality of devices in the virtual group;
generating a hostname accessed identifier to uniquely identify each of the accessed hostnames;
generating a request for each accessed hostname to perform one or more of, identifying user identifiable information collected by the accessed hostname, and deleting user identifiable information collected by the accessed hostname;
transmitting the request to each accessed hostname together with a user identifier to identify the selected one of the one or more identified users; and
receiving one or more responses to the request and providing the one or more responses to the selected one of the one or more identified users.

35. The computerized method of claim 34 wherein the operation of generating a request for each accessed hostname to perform one or more of, identifying user identifiable information collected by the accessed hostname, and deleting user identifiable information collected by the accessed hostname comprises:
identifying a protocol by which each accessed hostname responds to a request to perform one or more of, identifying user identifiable information collected by the accessed hostname, and deleting user identifiable information collected by the accessed hostname, wherein the identifying of the protocol comprises: (i) checking a database of stored hostname protocols to determine if a protocol for the accessed hostname is stored; and (ii) if a protocol is not stored, retrieving one or more web pages from the accessed hostname and providing the retrieved web pages to a protocol identification engine to identify the protocol, wherein the protocol identification engine employs a trained machine learning engine trained to recognize a user identifiable information request protocol from text or images extracted from web pages.

36. A computer system that operates to identify user identifiable information, the computer system comprising one or more processors programmed to:
receive a request to identify user identifiable information pertaining to one or more identified users;
for a selected one of the one or more identified users,
scan a plurality of devices, wherein the plurality of devices form at least a portion of a virtual group, wherein the virtual group is formed of devices connected to a private network and one or more identified users that have access to the private network, wherein each device in the plurality of devices in the virtual group is accessible by the selected one of the one or more identified users to access an accessed server, wherein the scan is performed by way of a router or a computing device associated with the router that operates on the private network to centrally identify, for each device in the plurality of devices, URLs accessed by that device, and wherein the scan of the plurality of devices identifies a set of hostnames associated with servers located remotely from the one or more processors that have been accessed by way of the plurality of devices in the virtual group;
generate a hostname accessed identifier to uniquely identify each of the accessed hostnames;
generate a request for each accessed hostname to perform one or more of, identifying user identifiable information collected by the accessed hostname, and deleting user identifiable information collected by the accessed hostname;
transmit the request to each accessed hostname together with a user identifier to identify the selected one of the one or more identified users; and
receive one or more responses to the request and provide the one or more responses to the selected one of the one or more identified users.

37. The computer system of claim 36 wherein the request to identify user identifiable information pertaining to one or more identified users is generated by one of the one or more identified users.

38. The computer system of claim 36 wherein the request to identify user identifiable information pertaining to one or more identified users is generated periodically and automatically upon selection of an automatic request by one of the one or more identified users, wherein the automatic request is initiated by the one or more processors at a predetermined periodic interval without further input from the one or more identified users.

39. The computer system of claim 36 wherein the virtual group is automatically generated by:
operating the router or computing device associated with the router to periodically scan each of the plurality of devices connected to the private network to identify each user identifier employed by each of the devices to identify each individual using the corresponding device, and adding each identified device to the virtual group based on its connection to the private network and the user identifiers employed on that device.

40. The computer system of claim 36 wherein the operation whereby the computer system operates to scan a plurality of devices to identify a set of accessed servers that have been accessed by way of the plurality of devices comprises:
selecting a device of the plurality of devices;
scanning each selected device to identify files that may contain identifiers for accessed servers, wherein the scanning is performed by the router or the computing device associated with the router; and
extracting and storing URLs from files identified that may contain identifiers for accessed servers.
